(19) United States
(12) Patent Application Publication
(10) Pub. No.: US 2026/0171313 A1
(43) Pub. Date: Jun. 18, 2026

(54) MULTILAYER ELECTRONIC COMPONENT

(71) Applicant: SAMSUNG ELECTRO-MECHANICS CO., LTD., Suwon-si (KR)

(72) Inventors: Geon Ju LEE, Suwon-si (KR); Yong In KIM, Suwon-si (KR); Han Seong JUNG, Suwon-si (KR); Myeong Gi CHOE, Suwon-si (KR); Seok Hyun YOON, Suwon-si (KR)

(73) Assignee: SAMSUNG ELECTRO-MECHANICS CO., LTD., Suwon-si (KR)

(21) Appl. No.: 19/351,966

(22) Filed: Oct. 7, 2025

(30) Foreign Application Priority Data
Dec. 18, 2024 (KR) 10-2024-0190303

(51) Int. Cl. H01G 4/12; H01G 4/232; H01G 4/248; H01G 4/30

(52) U.S. Cl. CPC H01G 4/1227; H01G 4/232; H01G 4/248; H01G 4/30

(57) ABSTRACT

A multilayer electronic component according to an embodiment of the present disclosure includes a body including g a capacitance formation portion including a dielectric layer including (Ba, Ca)TiO₃ and BaTiO₃ as a main component and an internal electrode alternately disposed with the dielectric layer; and an external electrode disposed on the body, wherein, if a secondary phase including calcium (Ca) and titanium (Ti) and in which an atomic percentage of a rare earth element is 0.1 at % or more is referred to as a first secondary phase, the dielectric layer includes the first secondary phase, and based on a cross-sectional area of the capacitance formation portion, an area percentage of the first secondary phase included in the dielectric layer, excluding the internal electrode, is more than 0% and less than 4.58%.

### CROSS-REFERENCE TO RELATED APPLICATION(S)

This application claims benefit of priority to Korean Patent Application No. 10-2024-0190303 filed on Dec. 18, 2024 in the Korean Intellectual Property Office, the disclosure of which is incorporated herein by reference in its entirety.

### TECHNICAL FIELD

The present relates to a multilayer electronic component.

A multilayer ceramic capacitor (MLCC), a multilayer electronic component, may be a chip condenser mounted on the printed circuit boards of various types of electronic products such as image display devices including a liquid crystal display (LCD), a plasma display panel (PDP), or the like, a computer, a smartphone, a mobile phone, or the like, serving to charge or discharge electricity therein or therefrom.

Such a multilayer ceramic capacitor may be used as a component of various electronic devices, as the multilayer ceramic capacitor has a small size with high capacitance and is easily mounted. As various electronic devices such as computers, mobile devices, or the like have been miniaturized and implemented with high-output, demand for miniaturization and high capacitance of the multilayer ceramic capacitors has increased.

As the market for MLCCs for electric/electronic devices as well as IT is expanding, the demand for products with excellent reliability in high-voltage and high-temperature environments in the same capacitance range is increasing.

Meanwhile, it has been reported that even with the same dielectric composition, there may be a large difference in reliability depending on a microstructure, the distribution and solubility of elements of additives, and process conditions. Recently, when a secondary phase with a high amount of rare earth additives is appropriately formed without being dissolved in crystal grains in a dielectric layer, reliability or the like may be improved, and target temperature-dependent capacitance change characteristics (TCC characteristics) may be achieved, so researches thereon are actively being conducted.

### SUMMARY

One of problems to be solved by the present disclosure is to provide a multilayer electronic component having excellent high-temperature reliability.

One of problems to be solved by the present disclosure is to provide a multilayer electronic component implementing target TCC characteristics.

Problems to be solved by the present disclosure are not limited to the above-described contents, and will be more easily understood in the process of explaining specific embodiments of the present disclosure.

A multilayer electronic component according to an embodiment of the present disclosure includes a body a including a capacitance formation portion including dielectric layer including a main component that includes (Ba, Ca)TiO₃ and BaTiO₃, and internal electrodes alternately disposed with the dielectric layer; and an external electrode disposed on the body, wherein, the dielectric layer includes a first secondary phase including calcium (Ca), titanium (Ti), and 0.1 at % or more of a rare earth element, and based on a cross-sectional area of the capacitance formation portion, an area percentage of the first secondary phase included in the dielectric layer, excluding the internal electrodes, is more than 0% and less than 4.58%.

A multilayer electronic component to according another embodiment of the present disclosure includes a body including a capacitance formation portion including a dielectric layer and an internal electrode alternately disposed with the dielectric layer; and an external electrode disposed on the body, wherein the dielectric layer includes a first secondary phase and a second secondary phase, wherein the first secondary phase includes calcium (Ca), titanium (Ti), and 0.1 at % or more of a rare earth element, and the second secondary phase includes calcium (Ca), silicon (Si), titanium (Ti), and 0 at % or more and less than 0.1 at % of the rare earth element, wherein, based on a cross-sectional area of the capacitance formation portion, an area percentage of the first secondary phase included in the dielectric layer, excluding the internal electrodes, is more than 0% and less than 4.58%, and wherein, based on the cross-sectional area of the capacitance formation portion, an area percentage of the second secondary phase included in the dielectric layer, excluding the internal electrodes, is 0.05% or more and less than 0.1%.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 schematically illustrates a perspective view of a multilayer electronic component according to an embodiment of the present disclosure.

FIG. 2 schematically illustrates an exploded perspective view illustrating a stack structure of internal electrodes.

FIG. 3 schematically illustrates a cross-sectional view taken along line I-I′ of FIG. 1.

FIG. 4 schematically illustrates a cross-sectional view taken along line II-II′ of FIG. 1.

FIG. 5 schematically illustrates a cross-sectional view taken along line II-II′ of FIG. 1 according to another embodiment of the present disclosure.

FIG. 6 schematically illustrates an enlarged view of region P of FIG. 3.

FIG. 7A is an image of a cross-section of a dielectric layer of an embodiment of the present disclosure taken by a scanning transmission electron microscope (STEM), FIG. 7B is an image of silicon (Si) mapped in the same region by energy dispersive X-ray spectroscopy (EDS), and FIG. 7C is an image of rare earth elements (RE) mapped in the same region by energy dispersive X-ray spectroscopy (EDS).

FIG. 8A is an image of silicon (Si) mapped in a cross-section of a dielectric layer of another embodiment of the present disclosure taken by a scanning transmission electron microscope (STEM) and then by energy dispersive X-ray spectroscopy (EDS), and FIG. 8B is an image of rare earth elements (RE) mapped in the same region by energy dispersive X-ray spectroscopy (EDS).

FIG. 9A is an image of a cross-section of a capacitance formation portion of a comparative example, taken using a scanning transmission electron microscope (STEM), FIG. 9B is an image of elements mapped using energy-dispersive X-ray spectroscopy (EDS) for the same region as FIG. 9A, and FIG. 9C is an image of a region in which first secondary phases are distributed, selected and illustrated using a program built into a scanning transmission electron microscope (STEM), for the same region as FIG. 9A. FIG. 9D is an image of a cross-section of a capacitance formation portion of an example according to the present disclosure, taken using a scanning transmission electron microscope (STEM), FIG. 9E is an image of elements mapped using energy-dispersive X-ray spectroscopy (EDS) for the same region as FIG. 9D, and FIG. 9F is an image of a region in which first secondary phases included in the dielectric layer, relative to an area from which an internal electrode is excluded, are distributed, selected and illustrated using a program built into a scanning transmission electron microscope (STEM), based on a cross-sectional area of a capacitance formation portion, for the same region as FIG. 9D.

### DETAILED DESCRIPTION

Hereinafter, embodiments of the present disclosure will be described with reference to specific embodiments and the accompanying drawings. However, embodiments of the present disclosure may be modified into various other forms, and the scope of the present disclosure is not limited to the embodiments described below. Further, embodiments of the present disclosure may be provided for a more complete description of the present disclosure to the ordinary artisan.

Therefore, shapes, sizes, and the like, of the elements in the drawings may be exaggerated for clarity of description, and the elements denoted by the same reference numerals in the drawings may be the same elements.

In addition, in order to clearly explain the present disclosure in the drawings, portions not related to the description will be omitted for clarification of the present disclosure, and a thickness may be enlarged to clearly illustrate layers and regions. The same reference numerals will be used to designate the same components in the same reference numerals. Further, throughout the specification, when an element is referred to as “comprising” or “including” an element, it means that the element may further include other elements as well, without departing from the other elements, unless specifically stated otherwise.

In the drawings, a Z-direction may be defined as a first direction, a stack direction, or a thickness (T) direction, an X-direction may be defined as a second direction or a length (L) direction, and a Y direction may be defined as a third direction or a width (W) direction.

### Multilayer Electronic Component

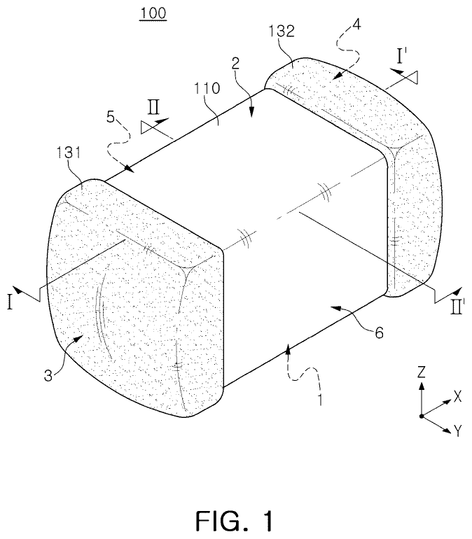

FIG. 1 schematically illustrates a perspective view of a multilayer electronic component according to an embodiment of the present disclosure.

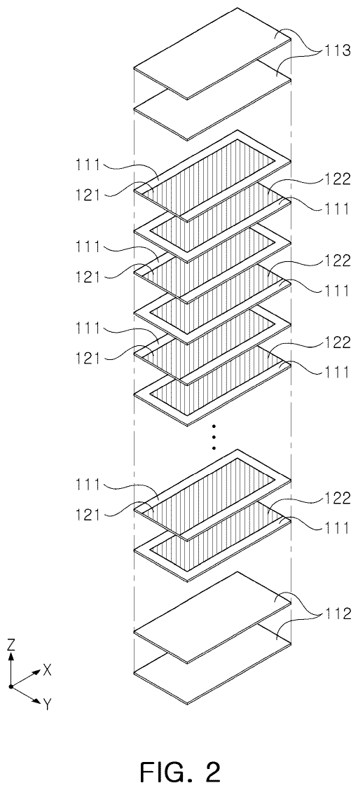

FIG. 2 schematically illustrates an exploded perspective view illustrating a stack structure of internal electrodes.

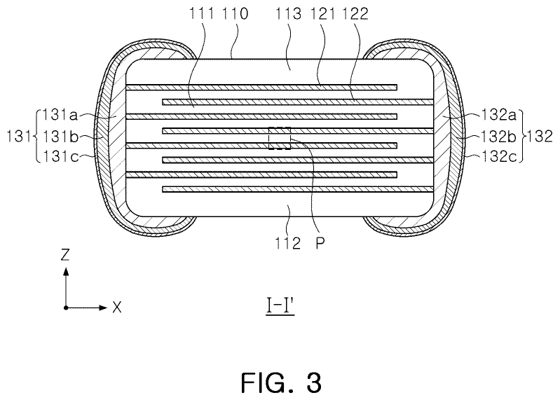

FIG. 3 schematically illustrates a cross-sectional view taken along line I-I′ of FIG. 1.

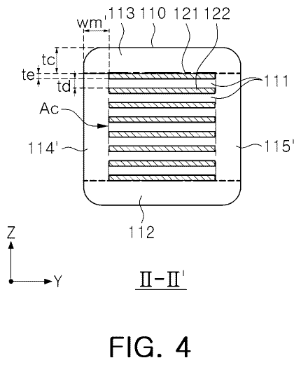

FIG. 4 schematically illustrates a cross-sectional view taken along line II-II′ of FIG. 1.

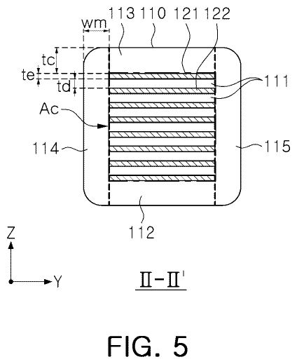

FIG. 5 schematically illustrates a cross-sectional view taken along line II-II′ of FIG. 1 according to another embodiment of the present disclosure.

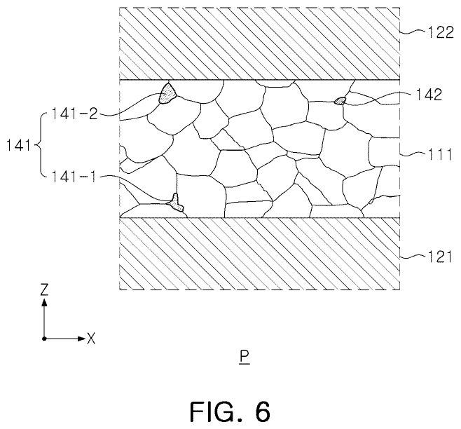

FIG. 6 schematically illustrates an enlarged view of region P of FIG. 3.

Hereinafter, a multilayer electronic component according to an embodiment of the present disclosure will be described in detail with reference to FIGS. 1 to 6. However, the present disclosure will be described with respect to a multilayer ceramic capacitor as an example of a multilayer electronic component, but the present disclosure may also be applied to various electronic products utilizing a dielectric composition, such as an inductor, a piezoelectric element, a varistor, a thermistor, or the like.

According to an embodiment of the present disclosure, a multilayer electronic component 100 includes a body 110 including a capacitance formation portion Ac including a dielectric layer 111 including (Ba, Ca)TiO₃ and BaTiO₃ as a main component and an internal electrode (121 and 122) alternately disposed with the dielectric layer 111; and an external electrode (131 and 132) disposed on the body 110, wherein, if a secondary phase including calcium (Ca) and titanium (Ti) and in which an atomic percentage of a rare earth element is 0.1 at % or more is referred to as a first secondary phase 141, the dielectric layer 111 includes the first secondary phase 141, and based on a cross-sectional area of the capacitance formation portion Ac, an area percentage of the first secondary phase 141 included in the dielectric layer 111, excluding the internal electrode, is more than 0% and less than 4.58%.

According to another embodiment of the present disclosure, a multilayer electronic component 100 includes a body 110 including a capacitance formation portion Ac including a dielectric layer 111 and an internal electrode (121 and 122) alternately disposed with the dielectric layer 111; and an external electrode (131 and 132) disposed on the body 110, wherein, if a secondary phase including calcium (Ca) and titanium (Ti) and in which an atomic percentage of a rare earth element is 0.1 at% or more is referred to as a first secondary phase 141, and a secondary phase including calcium (Ca), silicon (Si), and titanium (Ti) and in which an atomic percentage of a rare earth element is 0 at % or more and less than 0.1 at % is referred to as a second secondary phase 142, wherein the dielectric layer 111 includes the first and second secondary phases 141 and 142, wherein, based on a cross-sectional area of the capacitance formation portion Ac, an area percentage of the first secondary phase 141 included in the dielectric layer 111, excluding the internal electrode, is more than 0% and less than 4.58%, and wherein, based on a cross-sectional area of the capacitance formation portion Ac, an area percentage of the second secondary phase 142 included in the dielectric layer 111, excluding the internal electrode, is 0.05% or more and less than 0.1%.

In the body 110, the dielectric layer 111 and the internal electrode (121 and 122) may be alternately stacked.

More specifically, the body 110 may include the capacitance formation portion Ac disposed in the body 110 and including a first internal electrode 121 and a second internal electrode 122, alternately disposed to oppose each other, with the dielectric layer 111 interposed therebetween, to form capacitance.

Although a specific shape of the body 110 is not particularly limited, the body 110 may have a hexahedral shape or the like, as illustrated. Due to shrinkage of ceramic powder particles included in the body 110 during a sintering process, the body 110 may not have a perfectly straight hexahedral shape, but may have a substantially hexahedral shape.

The body 110 may include first and second surfaces 1 and 2 opposing each other in the first direction, third and fourth surfaces 3 and 4 connected to the first and second surfaces 1 and 2 and opposing each other in the second direction, and fifth and sixth surfaces 5 and 6 connected to the first to fourth surfaces 1, 2, 3, and 4 and opposing each other in the third direction.

A plurality of dielectric layers 111 forming the body 110 may be in a sintered state, and a boundary between adjacent dielectric layers 111 may be integrated to such an extent that it may be difficult to identify the same without using a scanning electron microscope (SEM).

A raw material for forming the dielectric layer 111 is not particularly limited, as long as sufficient capacitance may be obtained therewith. In general, a perovskite (ABO₃)-based material may be used, for example, a barium titanate-based material, a lead composite perovskite-based material, a strontium titanate-based material, or the like may be used. The barium titanate-based material may include a BaTiO₃-based ceramic powder, and examples of the ceramic powder may include BaTiO₃, or (Ba₁₋ₓCaₓ)TiO₃(0<x<1), Ba(Ti_{1-y}Ca_{y})O₃(0<y<1), (Ba₁₋ₓCaₓ)(Ti_{1-y}Zr_{y})O₃(0<x<1, 0<y<1), Ba(Ti_{1-y}Zr_{y})O₃(0<y<1), or the like, in which calcium (Ca), zirconium (Zr), or the like is partially dissolved in BaTiO₃, or the like.

To improve high-temperature reliability, rather than using only BaTiO₃, which has a Curie temperature (Tc) of approximately 120° C., as a main component raw material, it is easier to improve high-temperature reliability by using (Ba, Ca)TiO₃, which has a high Curie temperature, together or alone. For example, it is preferable to use (Ba, Ca)TiO₃ and/or BaTiO₃ as a main component, and it is more preferable that an amount (meaning wt %, at %, or mol %) of a (Ba, Ca)TiO₃ material may be greater than an amount (meaning wt %, at %, or mol %) of a BaTiO₃ material to improve high-temperature reliability, but it is not particularly limited thereto.

More specifically, for example, main components of the dielectric layer 111 may be consists of (Ba, Ca)TiO₃ and BaTiO₃, and when a total mole number (a total number of moles) of (Ba, Ca)TiO₃ and BaTiO₃ among the main components is 100, a mole ratio of (Ba, Ca)TiO₃:BaTiO₃ may be from 10:90 to 90:10, preferably from 50:50 to 90:10, and more preferably from 70:30 to 90:10.

When (Ba, Ca)TiO₃ and/or BaTiO₃ are used as a main component raw material, particles of (Ba, Ca)TiO₃ and/or BaTiO₃ may be included as the main component after sintering, which may mean that the dielectric layer 111 includes crystal grains having (Ba, Ca)TiO₃ and/or BaTiO₃ as a crystal lattice, as the main component.

In addition, various ceramic additives, organic solvents, binders, dispersants, or the like may be added to particles such as (Ba, Ca)TiO₃ and/or BaTiO₃, or the like, as the raw material for forming the dielectric layer 111, according to the purpose of the present disclosure.

More specifically, the dielectric layer 111 may include a main component of perovskite (ABO₃), for example, (Ba, Ca)TiO₃ and/or BaTiO₃ dielectric materials, particles or crystal grains, and an auxiliary component, and more specifically, the auxiliary component may include the following first to fifth auxiliary components.

In addition, in the present disclosure, as an example of a more specific method for measuring amounts of elements included in each configuration of the multilayer electronic component 100, components may be analyzed using an energy dispersive X-ray spectroscopy (EDS) mode of a scanning electron microscope (SEM), an EDS mode of a transmission electron microscope (TEM), or an EDS mode of a scanning transmission electron microscope (STEM). First, a thinned analysis sample may be prepared using a focused ion beam (FIB) device in a region to be measured. The thinned sample may be subjected to Xe or Ar ion milling to remove a damage layer on a surface, and then each component to be measured may be mapped from images obtained using an SEM-EDS, a TEM-EDS, or an STEM-EDS to conduct a qualitative/quantitative analysis. In this case, a qualitative/quantitative analysis graph of each component may be expressed by converting the same into a mass percentage (wt %), an atomic percentage (at %), or a mole percentage (mol %) of each element, and may also be expressed by converting an amount of another specific component to an amount of a specific component.

In another method, a chip may be pulverized to select a region to be measured, and the selected region including the dielectric microstructure may be analyzed for the components of the region including the dielectric microstructure using a device such as an inductively coupled plasma optical emission spectrometer (ICP-OES), an inductively coupled plasma mass spectrometer (ICP-MS), or the like. Other methods and/or tools appreciated by one of ordinary skill in the art, even if not described in the present disclosure, may also be used.

In addition, in the present disclosure, an amount of a material included in a certain configuration or region may mean an average value of materials included in a certain configuration or region, unless otherwise stated. For example, “first secondary phase 141 having an atomic percentage of a rare earth element of 0.1 at % or more” described below may mean that an average atomic percentage of rare earth elements included in the first secondary phase 141 is 0.1 at % or more. In addition, “mole number of the secondary element, relative to 100 moles of titanium (Ti) included in the dielectric layer 111” described below may mean an average mole number (an average number of moles) of the secondary element relative to 100 moles of titanium (Ti) included in the dielectric layer 111, and may be a value analyzed and measured in at least a portion of the dielectric layer 111.

In addition, in the present disclosure, the “main component” may mean a component occupying a relatively high weight ratio, a relatively high atomic number ratio, or a relatively high molar number ratio, as compared to other components, and may mean a component of 50 wt % or more based on a weight of the entire composition or the entire dielectric layer, a component of 50 at % or more based on an atomic number, or a component of 50 mol % or more based on the molar number. More specifically, for example, the dielectric layer may include (Ba, Ca)TiO₃ and/or BaTiO₃ as main components, may include ((Ba, Ca)TiO₃ and/or BaTiO₃ particles as main components, and may include (Ba, Ca)TiO₃ and/or BaTiO₃ crystal grains as main components. In this case, when (Ba, Ca)TiO₃ and BaTiO₃ may be included together, entire particles or entire crystal grains of (Ba, Ca)TiO₃ and BaTiO₃ may be used as main components.

Likewise, in the present disclosure, the “auxiliary component” may mean a component occupying a relatively low weight ratio, a relatively low atomic number ratio, or a relatively low molar number ratio, as compared to other components, and may mean a component of less than 50 wt % based on a weight of the entire composition or the entire dielectric layer, a component of less than 50 at % based on an atomic number, or a component of less than 50 mol % based on a molar number.

### a) First Auxiliary Component

According to an embodiment of the present disclosure, the dielectric layer 111 may include a first auxiliary component element, and the first auxiliary component element may be an atomic variable acceptor element, and the atomic variable acceptor element may be at least one of manganese (Mn), vanadium (V), chromium (Cr), iron (Fe), cobalt (Co), nickel (Ni), copper (Cu), or zinc (Zn), preferably at least one of manganese (Mn) or vanadium (V), and more preferably manganese (Mn) and vanadium (V).

The first auxiliary component element may be functional through an additive of at least one of an oxide or a carbonate of the atomic variable acceptor element, and may be added together with the main component raw material before sintering.

The first auxiliary component element, the atomic variable acceptor element, may play a role in improving a decrease in sintering temperature, dielectric properties, insulation resistance (IR), and high-temperature reliability properties.

In this case, a mole number (a number of moles) of the first auxiliary component element included in the dielectric layer 111, relative to 100 moles of titanium (Ti) included in the dielectric layer 111, may be 0.1 moles or more and 1.0 mole or less, and when the first auxiliary component element is in plural, a total mole number (a total number of moles) thereof may be defined as a mole number of the first auxiliary component element.

When a mole number of the first auxiliary component element included in the dielectric layer 111 is less than 0.1 mole relative to 100 moles of titanium (Ti) included in the dielectric layer 111, there may be a concern that insulation resistance (IR) decreases, and when a mole number of the first auxiliary component element included in the dielectric layer 111 is more than 1.0 mole relative to 100 moles of titanium (Ti) included in the dielectric layer 111, there may be a concern that a DC-bias change rate decreases.

### b) Second Auxiliary Component

According to an embodiment of the present disclosure, the dielectric layer 111 may include a second auxiliary component element, and the second auxiliary component element may be magnesium (Mg).

The second auxiliary component element may be functional through an additive of at least one of an oxide or a carbonate of magnesium (Mg), and may be added together with the main component raw material before sintering.

The second auxiliary component element, magnesium (Mg), may provide reduction resistance, and may play a role in increasing a reliability class (RC) value. In this case, the RC value may mean reliability according to a temperature, reliability at high temperature, reliability at high voltage, life evaluation, or the like.

In this case, a mole number of the second auxiliary component element included in the dielectric layer 111 relative to 100 moles of titanium (Ti) included in the dielectric layer 111 may be 0.2 moles or more and 0.4 moles or less.

When a mole number of the second auxiliary component element included in the dielectric layer 111 is less than 0.2 moles relative to 100 moles of titanium (Ti) included in the dielectric layer 111, there may be a concern that reliability is reduced, and when a mole number of the second auxiliary component element included in the dielectric layer 111 is more than 0.4 moles relative to 100 moles of titanium (Ti) included in the dielectric layer 111, there may be a concern that target TCC characteristics are not satisfied.

### c) Third Auxiliary Component

According to an embodiment of the present disclosure, the dielectric layer 111 may include a third auxiliary component element, and the third auxiliary component element may be a rare earth element, and the rare earth element may include at least one of yttrium (Y), samarium (Sm), dysprosium (Dy), terbium (Tb), holmium (Ho), erbium (Er), or gadolinium (Gd), but is not particularly limited thereto.

The third auxiliary component element, the rare earth element, may play a role in improving high-temperature reliability, and may play a role in improving reliability.

The third auxiliary component element may be functional through an additive of at least one of an oxide or a carbonate of the rare earth element, and may be added together with the main component raw material before sintering.

In this case, a mole number of the third auxiliary component element included in the dielectric layer 111 relative to 100 moles of titanium (Ti) included in the dielectric layer 111 may be 4.0 moles or more and 7.0 moles or less, and when the rare earth element is in plural, a total mole number thereof may be defined as a mole number of the third auxiliary component element.

When a mole number of the third auxiliary component element included in the dielectric layer 111 is less than 4.0 moles relative to 100 moles of titanium (Ti) included in the dielectric layer 111, there may be a concern that high-temperature reliability is deteriorated, and when a mole number of the third auxiliary component element included in the dielectric layer 111 is more than 7.0 moles relative to 100 moles of titanium (Ti) included in the dielectric layer 111, insulation resistance (IR) may be deteriorated or high-temperature reliability may be deteriorated due to n-type semiconductorization of the dielectric.

### d) Fourth Auxiliary Component

According to an embodiment of the present disclosure, the dielectric layer 111 may further include a fourth auxiliary component element including at least one of barium (Ba) or calcium (Ca) by an auxiliary component additive, and preferably, the fourth auxiliary component element may be at least one of barium (Ba) or calcium (Ca), and more preferably, barium (Ba) and calcium (Ca).

The fourth auxiliary component element may be functional through an additive of at least one of an oxide or a carbonate of at least one element among barium (Ba) and calcium (Ca). For example, the fourth auxiliary component element may be a concept to distinguish from at least one of barium (Ba) or calcium (Ca) included in the main component, and in the present disclosure, may mean a fourth auxiliary component element functional through a separate auxiliary component additive rather than the main component.

Since an amount of barium (Ba) and an amount of calcium (Ca) that may be detected in the dielectric layer due to BaTiO₃ and/or (Ba, Ca)TiOs, or the like that may be used as the main component, may be inaccurate, the description will be made based on an input amount of the dielectric composition before sintering, but unless otherwise stated, a detected amount in the dielectric layer may not be changed after sintering.

In this case, a mole number of the fourth auxiliary component element included in the dielectric layer 111 relative to 100 moles of titanium (Ti) included in the dielectric layer 111 may be 3.0 moles or more and 6.0 moles or less, and when the fourth auxiliary component element is in plural, a total mole number thereof may be defined as a mole number of the fourth auxiliary component element.

For example, a mole number of at least one of barium (Ba) or calcium (Ca) included in the dielectric layer 111 relative to 100 moles of titanium (Ti) included in the dielectric layer 111 may mean 103.0 moles or more and 106.0 moles or less.

When a mole number of the fourth auxiliary component element included in the dielectric layer 111 is less than 3.0 moles relative to 100 moles of titanium (Ti) included in the dielectric layer 111, there may be a concern that the dielectric properties deteriorates, and when a mole number of the fourth auxiliary component element included in the dielectric layer 111 is more than 6.0 moles relative to 100 moles of titanium (Ti) included in the dielectric layer 111, there may be a concern that dielectric properties or high-temperature withstand voltage deteriorates.

### e) Fifth Auxiliary Component

According to an embodiment of the present disclosure, the dielectric layer 111 may include a fifth auxiliary component element, and the fifth auxiliary component element may be silicon (Si).

The fifth auxiliary component element may be at least one of an oxide of silicon (Si), a carbonate of silicon (Si), or glass including silicon (Si), and may be added together with the main component raw material before sintering.

The fifth auxiliary component element, silicon (Si), may play a role of a sintering aid, may play a role of inducing grain growth of crystal grains, and may play a role of improving insulation resistance (IR) or high-temperature reliability.

In this case, a mole number of the fifth auxiliary component element included in the dielectric layer 111 relative to 100 moles of titanium (Ti) included in the dielectric layer 111 may be 1.0 mole or more and 2.0 moles or less.

When a mole number of the fifth auxiliary component element included in the dielectric layer 111 relative to 100 moles of titanium (Ti) included in the dielectric layer 111 is less than 1.0 mole, there may be a concern that sintering does not proceed sufficiently or room temperature dielectric constant decreases, and when a mole number of the fifth auxiliary component element included in the dielectric layer 111 relative to 100 moles of titanium (Ti) included in the dielectric layer 111 exceeds 2.0 mole, there may be a concern that insulation resistance (IR) decreases or high-temperature reliability decreases.

To distinguish it from a dielectric layer included in a cover portion (112 and 113) and a side margin portion (114 and 115), which will be described later, a dielectric layer included in the capacitance formation portion Ac may be defined as a first dielectric layer, a dielectric layer included in the cover portion (112 and 113) may be defined as a second dielectric layer, and a dielectric layer included in the side margin portion (114 and 115) may be defined as a third dielectric layer.

In addition, the first to third dielectric layers may be formed using a dielectric material such as (Ba, Ca)TiO₃ and/or BaTiO₃, and may thus include a dielectric microstructure after sintering. The dielectric microstructure may include a plurality of crystal grains, a crystal grain boundary disposed between adjacent crystal grains, and a triple point disposed at a point with which three or more crystal grain boundaries are in contact, and may include a plurality of crystal grains, a plurality of crystal grain boundaries, and a plurality of triple points, respectively. In this case, the crystal grains may have crystal lattices such as (Ba, Ca)TiO₃ and/or BaTiO₃ or the like, and may be due to the main component.

A first direction dimension td of the dielectric layer 111 does not need to be particularly limited.

To secure reliability of the multilayer electronic component 100 under a high voltage environment, the first direction dimension td of the dielectric layer 111 may be 10.0 μm or less, 8.0 μm or less, 7.0 μm or less, 6.0 μm or less, or 5.0 μm or less. In addition, to achieve miniaturization and high capacitance of the multilayer electronic component 100, the first direction dimension td of the dielectric layer 111 may be 4.0 μm or less, 3.5 μm or less, or 3.0 μm or less. To more easily achieve miniaturization and high capacitance, the first direction dimension td of the dielectric layer 111 may be 2.0 μm or less or 1.0 μm or less, preferably 0.6 μm or less, and more preferably 0.4 μm or less.

In this case, the first direction dimension td of the dielectric layer 111 may mean a first direction dimension td of the dielectric layer 111 disposed between the first and second internal electrodes 121 and 122.

The first direction dimension td of the dielectric layer 111 may mean a dimension, a distance, a size, a length, or the like of the dielectric layer 111 in the first direction, or may mean a thickness of the dielectric layer.

In this case, the first direction dimension td of the dielectric layer 111 may be a concept including a first direction dimension td of at least one of the plurality of dielectric layers 111, or may be a concept including a first direction dimension td of each of all the dielectric layers 111.

In addition, the first direction dimension td of the dielectric layer 111 may mean a first direction average dimension td of one dielectric layer 111, may mean a first direction average dimension td of each of the plurality of dielectric layers 111, or may mean a first direction average dimension td of the plurality of dielectric layers 111.

The first direction average dimension td of the dielectric layer 111 may be measured by scanning images of the first and second direction cross-sections of the body 110 with a scanning electron microscope (SEM) at 10,000× magnification. More specifically, the first direction average dimension td of one dielectric layer 111 may mean an average value calculated by measuring first direction dimensions of one dielectric layer 111 at five (5) equally spaced points in the second direction in scanned images. The five (5) equally spaced points may be designated in the capacitance formation portion Ac. In addition, when this average value measurement is extended to three dielectric layers 111 to measure an average value, the first direction average dimension td of the plurality of dielectric layers 111 may be further generalized.

The internal electrode (121 and 122) may be alternately stacked with the dielectric layer 111.

The internal electrode (121 and 122) may include a first internal electrode 121 and a second internal electrode 122, and the first and second internal electrodes 121 and 122 may be alternately disposed to oppose each other with the dielectric layer 111 forming the body 110 interposed therebetween, and may be exposed to third and fourth surfaces 3 and 4 of the body 110, respectively.

More specifically, the first internal electrode 121 may be spaced apart from the fourth surface 4, and may be exposed through the third surface 3, and the second internal electrode 122 may be spaced apart from the third surface 3 and exposed through the fourth surface 4. A first external electrode 131 may be disposed on the third surface 3 of the body 110, and may be connected to the first internal electrode 121, and a second external electrode 132 may be disposed on the fourth surface 4 of the body 110, and may be connected to the second internal electrode 122.

For example, the first internal electrode 121 may be connected to the first external electrode 131 without being connected to the second external electrode 132, and the second internal electrode 122 may be connected to the second external electrode 132 without being connected to the first external electrode 131. In this case, the first and second internal electrodes 121 and 122 may be electrically separated from each other by the dielectric layer 111 disposed therebetween.

The body 110 may be formed by alternately stacking and then sintering a first ceramic green sheet on which a paste for the first internal electrode, which will be the first internal electrode 121, is printed, and a second ceramic green sheet on which a paste for the second internal electrode, which will be the second internal electrode 122, is printed, and then sintering the sheets.

A material forming the internal electrode (121 and 122) is not particularly limited, and a material having excellent electrical conductivity may be used. For example, the internal electrode (121 and 122) may include one or more of nickel (Ni), copper (Cu), palladium (Pd), silver (Ag), gold (Au), platinum (Pt), tin (Sn), tungsten (W), titanium (Ti), and an alloy thereof.

In addition, the internal electrode (121 and 122) may be formed by printing a conductive paste for internal electrodes including one or more of nickel (Ni), copper (Cu), palladium (Pd), silver (Ag), gold (Au), platinum (Pt), tin (Sn), tungsten (W), titanium (Ti), and an alloy thereof on a ceramic green sheet. The printing method of the conductive paste for internal electrodes may use a screen printing method, a gravure printing method, or the like, but the present disclosure is not limited thereto.

A first direction dimension the of the internal electrode (121 and 122) does not need to be specifically limited, and the description of the first direction dimension the of the internal electrode (121 and 122) hereinafter may refer to a first direction dimension the of each of the first internal electrode 121 and the second internal electrode 122.

To secure reliability of the multilayer electronic component 100 under a high voltage environment, the first direction dimension the of the internal electrode (121 and 122) may be 3.0 μm or less. In addition, to achieve miniaturization and high capacitance of the multilayer electronic component 100, the first direction dimension the of the internal electrode (121 and 122) may be 1.0 μm or less. To more easily achieve ultra-miniaturization and high capacitance, the first direction dimension the of the internal electrode (121 and 122) may be 0.6 μm or less, and more preferably 0.4 μm or less.

In this case, the first direction dimension the of the internal electrode (121 and 122) may be a concept including a first direction dimension the of at least one of a plurality of internal electrodes (121 and 122), or may be a concept including a first direction dimension the of all the internal electrode (121 and 122).

In this case, the first direction dimension the of the internal electrode (121 and 122) may mean a dimension, a distance, a size, a length, or the like of the internal electrode (121 and 122) in the first direction, or may mean a thickness of the internal electrode (121 and 122).

In this case, the first direction dimension the of the internal electrode (121 and 122) may be a concept including a first direction dimension the of at least one of the plurality of internal electrodes (121 and 122), or may be a concept including a first direction dimension the of each of all the internal electrode (121 and 122).

In addition, the first direction dimension the of the internal electrode (121 and 122) may mean a first direction average dimension the of one of the internal electrode (121 and 122), or may mean a first direction average dimension the of each of the plurality of internal electrodes (121 and 122), or may mean a first direction average dimension the of the plurality of internal electrodes (121 and 122).

The first direction average dimension the of the internal electrode (121 and 122) may be measured by scanning images of first and second direction cross-sections of the body 110 with a scanning electron microscope (SEM) at 10,000 magnification. More specifically, the first average dimension the of one internal electrode (121 and 122) may be an average value calculated by measuring first direction dimensions of one internal electrode at five (5) equally spaced points in the second direction in the scanned images.

The five (5) equally spaced points may be designated in the capacitance formation portion Ac. In addition, when this average value measurement is extended to three internal electrodes (121 and 122) and an average value thereof is measured, a first direction average dimension the of a plurality of internal electrodes (121 and 122) may be further generalized.

In an embodiment of the present disclosure, the first direction dimension td of at least one of the plurality of dielectric layers 111 and the first direction dimension the of at least one of the plurality of internal electrodes (121 and 122) may satisfy 2×te<td.

For example, the first direction dimension td of one of the dielectric layers 111 may be greater than twice the first direction dimension the of one of the internal electrode (121 and 122). Preferably, the first direction average dimension td of the plurality of dielectric layers 111 may be greater than twice the first direction average dimension the of the plurality of internal electrodes (121 and 122).

In general, for high-voltage electric/electronic components, a major issue may be reliability due to a decrease in breakdown voltage (BDV) in a high-voltage environment.

Therefore, to prevent a decrease in breakdown voltage under a high voltage environment, breakdown voltage characteristics may be improved by making the first direction average dimension td of the dielectric layer 111 larger than twice the first direction average dimension the of the internal electrode (121 and 122).

When the first direction average dimension td of the dielectric layer 111 is twice or less the first direction average dimension the of the internal electrode (121 and 122), breakdown voltage may decrease and a short circuit may occur between the internal electrodes.

The body 110 may include a cover portion (112 and 113) disposed on both end-surfaces of the capacitance formation portion Ac in the first direction.

Specifically, the cover portion (112 and 113) may include a first cover portion 112 disposed on one surface of the capacitance formation portion Ac in the first direction, and a second cover portion 113 disposed on the other surface of the capacitance formation portion Ac in the first direction. More specifically, the cover portion (112 and 113) may include an upper cover portion 112 disposed below the capacitance formation portion Ac in the first direction, and a lower cover portion 113 disposed above the capacitance formation portion Ac in the first direction.

The first cover portion 112 and the second cover portion 113 may be formed by disposing or stacking a single second dielectric layer 111 or two or more second dielectric layers 111 on upper and lower surfaces of the capacitance formation portion Ac in the first direction, respectively, and may basically play a role in preventing damage to the internal electrode (121 and 122) due to physical or chemical stress.

The first cover portion 112 and the second cover portion 113 may not include the internal electrode (121 and 122), and may include the same dielectric material as the first dielectric layer 111 of the capacitance formation portion Ac. For example, the first cover portion 112 and the second cover portion 113 may include a dielectric material, and may include, for example, a dielectric material such as (Ba, Ca)TiO₃ and/or BaTiO₃, or the like.

A first direction dimension tc of the cover portion (112 and 113) does not need to be particularly limited, and the following description of the first direction dimension tc of the cover portion (112 and 113) may mean a first direction dimension tc of each of the first cover portion 112 and the second cover portion 113.

To more easily achieve miniaturization and high capacitance of the multilayer electronic component 100, the first direction dimension tc of the cover portion (112 and 113) may be 100 μm or less, 90 μm or less, 80 μm or less, 70 μm or less, 60 μm or less, or 50 μm or less, preferably 30 μm or less, and more preferably 20 μm or less in ultra-small products.

In this case, the first direction dimension tc of the cover portion (112 and 113) may mean a first direction dimension of the cover portion (112 and 113).

In addition, the first direction dimension tc of the cover portion (112 and 113) may mean a first direction average dimension tc of each of the first and second cover portions 112 and 113, or may mean a first direction average dimension tc of the first and second cover portions 112 and 113.

The first direction average dimension tc of the cover portion (112 and 113) may be measured by scanning images of the first and second direction cross-sections of the body 110 with a scanning electron microscope (SEM) at 10,000× magnification. More specifically, the first direction average dimension tc may mean an average value calculated by measuring first direction dimensions at five (5) equally spaced points in the second direction in scanned images of one cover portion (112 and 113).

In addition, the first direction average dimension tc of the cover portion (112 and 113) measured by the above-described method may have a value substantially the same as the first direction average dimension of the cover portion (112 and 113) in the first and third direction cross-sections of the body 110.

The multilayer electronic component 100 may include a side margin region (114′ and 115′) which may be a third direction end region of the internal electrode (121 and 122).

More specifically, the side margin region (114′ and 115′) may include a first side margin region 114′ disposed between the internal electrode (121 and 122) and the fifth surface 5, and a second side margin region 115′ disposed between the internal electrode (121 and 122) and the sixth surface 6.

As illustrated, the side margin region (114′ and 115′) may mean a region between third direction ends of the first and second internal electrodes 121 and 122 and a boundary surface of the body 110, based on the first and third direction cross-sections of the body 110.

The side margin region (114′ and 115′) may refer to a ceramic green sheet region excluding the internal electrode (121 and 122) when a paste for the internal electrode is applied to a ceramic green sheet applied to the capacitance formation portion Ac except for the side margin region (114′ and 115′).

The side margin region (114′ and 115′) may basically play a role in preventing damage to the internal electrode (121 and 122) due to physical or chemical stress.

The first side margin region 114′ and the second side margin region 115′ may not include the internal electrode (121 and 122), and may include the same material as the first dielectric layer 111, for example, may correspond to a portion of the first dielectric layer 111. For example, the first side margin region 114′ and the second side margin region 115′ may include a dielectric material, and may include a dielectric material such as, for example, (Ba, Ca)TiO₃ and/or BaTiO₃, or the like.

A third direction dimension wm′ of the side margin region (114′ and 115′) does not need to be particularly limited, and the following description of the third direction dimension wm′ of the side margin region (114′ and 115′) may mean a third direction dimension wm′ of each of the first side margin region 114′ and the second side margin region 115′.

To more easily achieve miniaturization and high capacitance of the multilayer electronic component 100, the third direction dimension wm′ of the side margin region (114′ and 115′) may be 50 μm or less, preferably 30 μm or less, and more preferably 20 μm or less in ultra-small products.

In this case, the third direction dimension wm′ of the side margin region (114′ and 115′) may mean a dimension, a distance, a size, a length, or the like of the side margin region (114′ and 115′) in the third direction, or may mean a width of the side margin region (114′ and 115′).

In addition, the third direction dimension wm′ of the side margin region (114′ and 115′) may mean a third direction average dimension wm′ of each of the first and second side margin regions 114′ and 115′, or may mean a third direction average dimension wm′ of the first and second side margin regions 114′ and 115′.

The third direction average dimension wm′ of the side margin region (114′ and 115′) may be measured by scanning images of the first and third direction cross-sections of the body 110 with a scanning electron microscope (SEM) at 10,000× magnification. More specifically, the third direction average dimension wm′ may mean an average value calculated by measuring third direction dimensions at five (5) equally spaced points in the first direction in scanned images of the side margin region (114′ and 115′).

The multilayer electronic component 100 may include a side margin portion (114 and 115) disposed on third direction end-surfaces of the body 110. More specifically, the side margin portion (114 and 115) may include a first side margin portion 114 disposed on the fifth surface 5 of the body 110, and a second side margin portion 115 disposed on the sixth surface 6 of the body 110.

The side margin portion (114 and 115) may be formed by applying a conductive paste to a ceramic green sheet applied to the capacitance formation portion Ac, except for a portion in which the side margin portion (114 and 115) is formed, thereby forming the internal electrode (121 and 122), and to suppress a step difference caused by the internal electrode (121 and 122), the internal electrode (121 and 122) after stacking may be cut to be exposed to the fifth and sixth surfaces 5 and 6 of the body 110, and then a single third dielectric layer or two or more third dielectric layers may be formed by disposing or stacking them in the third direction on both end-surfaces of the capacitance formation portion Ac.

The side margin portion (114 and 115) may basically play a role in preventing damage to the internal electrode (121 and 122) due to physical or chemical stress.

The first side margin portion 114 and the second side margin portion 115 may not include the internal electrode (121 and 122), and may include the same material as the first dielectric layer 111. For example, the first side margin portion 114 and the second side margin portion 115 may include a dielectric material, and may include, for example, a dielectric material such as (Ba, Ca)TiO₃ and/or BaTiO₃, or the like.

A third direction dimension wm of the side margin portion (114 and 115) does not need to be specifically limited, and the following description of the third direction dimension wm of the side margin portion (114 and 115) may mean a third direction dimension wm of each of the first side margin portion 114 and the second side margin portion 115.

To more easily achieve miniaturization and high capacitance of the multilayer electronic component 100, the third direction dimension wm of the side margin portion (114 and 115) may be 50 μm or less, preferably 30 μm or less, and more preferably 20 μm or less in ultra-small products.

In this case, the third direction dimension wm of the side margin portion (114 and 115) may mean a dimension, a distance, a size, a length, or the like of the side margin portion (114 and 115) in the third direction, or may mean a width of the side margin portion (114 and 115).

In addition, the third direction dimension wm of the side margin portion (114 and 115) may mean a third direction average dimension wm of each of the first and second side margin portions 114 and 115, or may mean a third direction average dimension wm of the first and second side margin portions 114 and 115.

The third direction average dimension wm of the side margin portion (114 and 115) may be measured by scanning images of the first and third direction cross-sections of the body 110 with a scanning electron microscope (SEM) at 10,000× magnification. More specifically, the third direction average dimension wm may mean an average value calculated by measuring third direction dimensions at five (5) equally spaced points in the first direction in an image of one side margin portion (114 and 115).

In an embodiment of the present disclosure, a structure in which a multilayer electronic component 100 has two external electrodes (131 and 132) is illustrated, but the number, shapes, or the like of the external electrode (131 and 132) may be changed depending on a shape of the internal electrode (121 and 122) or other purposes.

The external electrode (131 and 132) may be disposed on the body 110 and connected to the internal electrode (121 and 122).

More specifically, the external electrode (131 and 132) may include first and second external electrodes 131 and 132 disposed on the third and fourth surfaces 3 and 4 of the body 110, respectively, and connected to the first and second internal electrodes 121 and 122, respectively. For example, the first external electrode 131 may be disposed on the third surface 3 of the body, and may be connected to the first internal electrode 121, and the second external electrode 132 may be disposed on the fourth surface 4 of the body, and may be connected to the second internal electrode 122.

In addition, the external electrode (131 and 132) may be disposed to extend on portions of the first and second surfaces 1 and 2 of the body 110, or may be disposed to extend on portions of the fifth and sixth surfaces 5 and 6 of the body 110. For example, the first external electrode 131 may be disposed on portions of the first, second, fifth, and sixth surfaces 1, 2, 5, and 6 of the body 110, and the second external electrode 132 may be disposed on portions of the first, second, fifth, and sixth surfaces 1, 2, 5, and 6 of the body 110.

The external electrode (131 and 132) may be formed of any material as long as they have electrical conductivity, such as metal or the like, and a specific material may be determined in consideration of electrical characteristics, structural stability, or the like, and may further have a multilayer structure.

For example, the external electrode (131 and 132) may include a first electrode layer (131a and 132a) disposed on the body 110, and a second electrode layer (131b and 132b) disposed on the first electrode layer (131a and 132a). Furthermore, the external electrode may include a third electrode layer (131c and 132c) disposed on the second electrode layer (131b and 132b).

In this case, it is preferable that the first to third electrode layers correspond to layers that may be distinguished from each other. However, it is not particularly limited thereto, and may be distinguished according to an order of manufacturing processes, and at least some layers among the first to third electrode layers may not be distinguished from each other, and may be observed as one layer.

In the present disclosure, “distinguished” may mean that two layers may be distinguished due to physical differences, chemical differences, and/or simple optical differences, and are not particularly limited thereto, but layers may be distinguished by the presence or absence of an “interface.” The interface may mean a surface on which two layers contacting each other are distinguishable from each other, and may mean a state in which the two layers may be distinguishable, for example, by differences in components through energy dispersive X-ray spectroscopy (EDS) analysis in equipment such as a scanning electron microscope (SEM).

The first electrode layer (131a and 132a) and the second electrode layer (131b and 132b) may be formed by transferring a sheet including a conductive metal onto the body 110, or may be formed by applying a conductive paste for an external electrode including a conductive metal to the body 110 and then sintering the same, or may be formed by dipping the body 110 into a conductive paste for an external electrode including a conductive metal, but are not particularly limited thereto.

For a more specific example of the electrode layers (131a, 132a, 131b, and 132b), the electrode layers (131a, 132a, 131b, and 132b) may have a two-layer structure including the first electrode layer (131a and 132a) and the second electrode layer (131b and 132b).

More specifically, the external electrode (131 and 132) may include a first electrode layer (131a and 132a) including a first conductive metal and glass, and a second electrode layer (131b and 132b) including a second conductive metal and a resin that may be distinguished from the first electrode layer (131a and 132a), and may be disposed on the first electrode layer (131a and 132a).

A material having excellent electrical conductivity may be used as the conductive metal included in the electrode layers (131a, 132a, 131b, 132b). For example, the conductive metal may include one or more selected from the group consisting of nickel (Ni), copper (Cu), palladium (Pd), silver (Ag), gold (Au), platinum (Pt), tin (Sn), tungsten (W), titanium (Ti), and an alloy thereof, but is not particularly limited thereto.

In this case, the conductive metal included in the first electrode layer (131a and 132a) may be referred to as a first conductive metal, and the conductive metal included in the second electrode layer (131b and 132b) may be referred to as a second conductive metal. In this case, the first conductive metal and the second conductive metal may be the same or different from each other, and in a case in which a plurality of conductive metals are included, only a portion thereof may include the same conductive metal, but are not particularly limited thereto.

The glass included in the first electrode layer (131a and 132a) may play a role of improving bonding with the body 110, and the resin included in the second electrode layer (131b and 132b) may play a role of improving bending strength.

The first conductive metal included in the first electrode layer (131a and 132a) may play a role of electrically connecting with the internal electrode (121 and 122).

The first conductive metal included in the first electrode layer (131a and 132a) is not particularly limited as long as it is a material electrically connected with the internal electrode (121 and 122), and for example, may include at least one of nickel (Ni), copper (Cu), palladium (Pd), silver (Ag), gold (Au), platinum (Pt), tin (Sn), tungsten (W), titanium (Ti), and an alloy thereof.

The second conductive metal included in the second electrode layer (131b and 132b) may perform a role of electrically connecting with the first electrode layer (131a and 132a).

The second conductive metal included in the second electrode layer (131b and 132b) is not particularly limited as long as it is a material electrically connected with the first electrode layer (131a and 132a), and may include at least one of nickel (Ni), copper (Cu), palladium (Pd), silver (Ag), gold (Au), platinum (Pt), tin (Sn), tungsten (W), titanium (Ti), and an alloy thereof.

The second conductive metal included in the second electrode layer (131b and 132b) may include at least one of a spherical particle or a flake-shaped particle. For example, the second conductive metal may be consists of only flake-shaped particles, only spherical particles, or a mixed form of flake-shaped particles and spherical particles.

In this case, the spherical particle may also include a shape that may not be completely spherical, for example, a shape in which a length ratio of a major axis and a minor axis (major axis/minor axis) is 1.45 or less. The flake-type particle refers to a particle having a flat and elongated shape, and is not particularly limited, but for example, a length ratio of a major axis and a minor axis (major axis/minor axis) may be 1.95 or more. Lengths of the major and minor axes of the spherical particle and the flake-shaped particle may be measured from images obtained by scanning cross-sections in the first and second directions cut from a central portion of the multilayer electronic component in the third direction with a scanning electron microscope (SEM).

The resin included in the second electrode layer (131b and 132b) may play a role in securing bonding properties and absorbing shock, and is not particularly limited as long as it is mixed with the fourth conductive metal particle to make a paste, and may include, for example, an epoxy-based resin.

In addition, the second electrode layer (131b and 132b) may include an intermetallic compound.

The intermetallic compound may be included to further improve electrical connectivity with the first electrode layer (131a and 132a). The intermetallic compound may serve to improve electrical connectivity by connecting a plurality of second conductive metal particles, and may serve to surround and connect the plurality of second conductive metal particles to each other.

In this case, the intermetallic compound may include a metal having a melting point, lower than a curing temperature of a resin. For example, since the intermetallic compound includes a metal having a melting point, lower than a curing temperature of a resin, the metal having a melting point, lower than a curing temperature of a resin, may melt during a drying process and a curing process to form some of metal particles and the intermetallic compound, to surround the metal particles. In this case, the intermetallic compound may include a low melting point metal of 300° C. or less. More specifically, for example, the intermetallic compound may include tin (Sn) having a melting point of 213 to 220° C. During the drying process and the curing process, tin (Sn) may be melted, and the melted tin (Sn) may wet the metal particles having a high melting point, such as silver (Ag), nickel (Ni), or copper (Cu), by capillary action, and may react with a portion of silver (Ag), nickel (Ni), or copper

(Cu) metal particles to form intermetallic compounds such as Ag₃Sn, Ni₃Sn₄, CuSns, Cu₃Sn, or the like. Silver (Ag), nickel (Ni), or copper (Cu) that did not participate in the reaction may remain as metal particles.

Therefore, the plurality of second conductive metal particles may include at least one of silver (Ag), nickel (Ni), or copper (Cu), and the intermetallic compounds may include one or more of Ag₃Sn, Ni₃Sn₄, CuSns, and Cu₃Sn.

The third electrode layer (131c and 132c) may play a role in improving mounting characteristics, and may be a plating layer formed on the second electrode layer (131b and 132b) by a plating method, but is not particularly limited thereto.

A type of the third electrode layer (131c and 132c) is not particularly limited, and for example, may include at least one of nickel (Ni), tin (Sn), silver (Ag), palladium (Pd), or an alloy thereof.

The third electrode layer (131c and 132c) may be a single layer or may be a plurality of layers.

More specifically, for example, the third electrode layer (131c and 132c) may be a nickel (Ni) electrode layer or a tin (Sn) electrode layer, and may be in a configuration in which a nickel (Ni) electrode layer and a tin (Sn) electrode layer are sequentially formed on the second electrode layer (131b and 132b), or may be in a configuration in which a tin (Sn) electrode layer, a nickel (Ni) electrode layer, and a tin (Sn) electrode layer are sequentially formed. In addition, the third electrode layer (131c and 132c) may include a plurality of nickel (Ni) electrode layers and/or a plurality of tin (Sn) electrode layers.

A size of the multilayer electronic component 100 does not need to be specifically limited.

To improve reliability under high temperature and high voltage environments, an effect according to the present disclosure may be more prominent in the multilayer electronic component 100 having a size of 1608 (length×width: 1.6 mm×0.8 mm, length and width satisfy an error of +10%) or larger. On the other hand, to simultaneously achieve miniaturization and high capacitance, thicknesses of the dielectric layer and the internal electrode should be thinned to increase the number of laminates, so an effect according to the present disclosure may be more noticeable in the multilayer electronic component 100 having a size of 1608 (length×width: 1.6 mm×0.8 mm, length and width satisfy an error of +10%) or smaller.

Hereinafter, a multilayer electronic component 100 according to an embodiment of the present disclosure will be described in more detail.

In addition, in the present disclosure, “secondary phase” may mean a particle, a crystal grain, an oxide or segregation having a different composition or a different crystal lattice from a perovskite (ABO₃)-based material, particle, or crystal grain, as a main component, and may mean a collection of components not dissolved in the crystal grain, but is not particularly limited thereto.

In an embodiment of the present disclosure, when a secondary phase including calcium (Ca) and titanium (Ti) and having an atomic percentage of rare earth elements of 0.1 at % or more may be referred to as a first secondary phase 141, the dielectric layer 111 may include the first secondary phase 141. In this case, based on a cross-sectional area of the capacitance formation portion Ac, an area percentage of the first secondary phase 141 included in the dielectric layer 111, excluding the internal electrode, may have a lower limit of more than 0%, 0.2% or more, or 1.26% or more, and an upper limit of less than 4.58%, 4.0% or less, or 2.94% or less. In this case, the first secondary phase 141 may be an oxide including oxygen (O), but is not particularly limited thereto, and may have a crystal structure or be amorphous.

In this case, the first secondary phase 141 may include at least one of a 1-1 secondary phase 141-1 in which an atomic percentage of silicon (Si) is 1 at % or more, and a 1-2 secondary phase 141-2 in which an atomic percentage of silicon (Si) is 0 at % or more and less than 1 at %. For example, the first secondary phase 141 may include a 1-1 secondary phase 141-1 further including silicon (Si), and a 1-2 secondary phase 141-2 substantially not including silicon (Si). In this case, the 1-1 secondary phase 141-1 may be amorphous and not have a fixed shape, and the 1-2 secondary phase 141-2 may have a fixed shape (e.g., facet) such as a polygon, but are not particularly limited thereto.

More specifically, if a total number of atoms of all elements in the first secondary phase 141 is 100 at %, calcium (Ca) may be 2.0 at % or more and 10.0 at % or less, titanium

(Ti) may be 5.0 at % or more and 25.0 at % or less, and rare earth elements may be 0.1 at % or more and 30.0 at % or less. In this case, it is preferable that a ratio of an atomic percentage of the rare earth element to an atomic percentage of calcium (Ca) is 3.0 or more, but is not particularly limited thereto.

Among the first secondary phase 141, the 1-1 secondary phase 141-1 may have an atomic percentage of silicon (Si) of 1.0 at % or more and 10.0 at % or less, and among the first secondary phase 141, the 1-2 secondary phase 141-2 may have an atomic percentage of silicon (Si) of 0 at % or more and less than 1.0 at8. For example, the 1-2 secondary phase 141-2 may not include silicon (Si) (when an atomic percentage of Si is 0 at %), or may include it but less than 1 at %, which may be a noise level (when an atomic percentage of Si is more than 0 at % and less than 1 at %).

In addition, the rare earth element included in the first secondary phase 141 may be the same as the rare earth element included in the dielectric layer 111, and may include, for example, at least one of yttrium (Y), samarium (Sm), dysprosium (Dy), terbium (Tb), holmium (Ho), erbium (Er), or gadolinium (Gd), but is not particularly limited thereto.

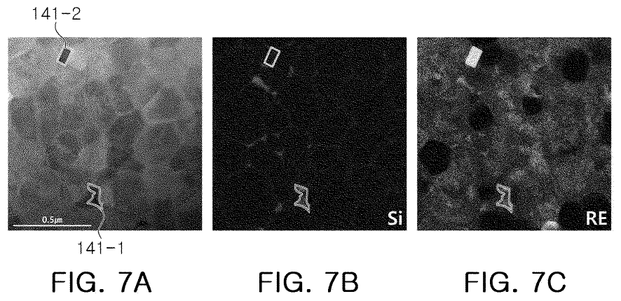

More specifically, referring to an embodiment of the present disclosure, FIG. 7A is an image of a cross-section of a dielectric layer of an embodiment of the present disclosure taken by a scanning transmission electron microscope (STEM), FIG. 7B is an image of silicon (Si) mapped in the same region by energy dispersive X-ray spectroscopy (EDS), and FIG. 7C is an image of rare earth elements (RE) mapped in the same region by energy dispersive X-ray spectroscopy (EDS). The 1-1 secondary phase 141-1 may not have a fixed shape and the atomic percentage of silicon (Si) was detected as 1 at % or more, whereas the 1-2 secondary phase 141-2 showed a polygonal shape and the atomic percentage of silicon (Si) was detected as less than 1 at %, and the atomic percentage of yttrium (Y), a rare earth element, was detected as 0.1 at % or more in both the 1-1 secondary phase 141-1 and the 1-2 secondary phase 141-2. Separate EDS analysis images for calcium (Ca) and titanium (Ti) were not attached, but both the 1-1 and 1-2 secondary phases 141-1 and 141-2 contained calcium (Ca) and titanium (Ti).

Based on a cross-sectional area of the capacitance formation portion Ac, an area percentage of the first secondary phase 141 included in the dielectric layer 111, excluding the internal electrode, may be greater than 0% and less than 4.58%, such that high-temperature reliability may be excellent.

When an area percentage of the first secondary phase 141 included in the dielectric layer 111, excluding the internal electrode, is 4.58% or more, based on a cross-sectional area of the capacitance formation portion Ac, there may be a concern that high-temperature reliability is not excellent.

Based on a cross-sectional area of the capacitance formation portion Ac, an area percentage of the first secondary phase 141 included in the dielectric layer 111, excluding the internal electrode, may be obtained by the following method, but is not particularly limited thereto. First, an 8 μm×8 μm cross-sectional area in the capacitance formation portion Ac among the first and second cross-sections from the third direction center of the body 110 may be photographed using a scanning transmission electron microscope (STEM), or the like (STEM, SEM, TEM), and then various elements may be detected through EDS analysis to classify the internal electrode (121 and 122), the dielectric layer 111, and/or the first secondary phase 141. For example, the main component element (e.g., nickel (Ni)) of the internal electrode (121 and 122) may be mapped to classify the internal electrode (121 and 122) among the 8 μm×8 μm cross-sectional areas in the capacitance formation portion Ac. In this case, a remaining area excluding the internal electrode (121 and 122) may correspond to the dielectric layer 111, but is not particularly limited thereto. Rare earth elements, calcium (Ca), silicon (Si), and titanium (Ti) may be mapped to classify a region simultaneously including rare earth elements, calcium (Ca), and titanium (Ti) in the dielectric layer 111 as a first secondary phase 141 (for specific criteria on the atomic percentage of each element, refer to the element amount of the first secondary phase 141 described above). In this case, in the first secondary phase 141, an atomic percentage of silicon (Si) of 0.1 at % or more may be classified as a 1-1 secondary phase 141-1, and an atomic percentage of silicon (Si) of 0 at % or more and less than 0.1 at& may be classified as a 1-2 secondary phase 141-2. Thereafter, an area of the first secondary phase 141 that has completed classification may be measured using a program built into a scanning transmission electron microscope (STEM) (including other external programs such as ‘Image J,’ ‘Image Pro Plus,’ or the like), and then an area of the first secondary phase 141 may be expressed as a percentage, relative to an area from which the internal electrode (121 and 122) is excluded, based on the 8 μm×8 μm cross-sectional area of the capacitance formation portion Ac. Other methods and/or tools appreciated by one of ordinary skill in the art, even if not described in the present disclosure, may also be used.

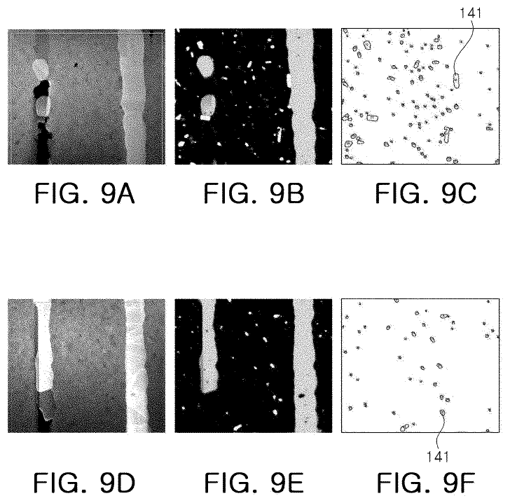

More specifically, for example, FIG. 9A is an image of a cross-section of a capacitance formation portion of Test Example 9 described below, taken using a transmission electron microscope (TEM), FIG. 9B is an image of elements mapped using energy-dispersive X-ray spectroscopy (EDS) for the same region as FIG. 9A, and FIG. 9C is an image of a region in which first secondary phases are distributed, selected and illustrated using a program built into a scanning transmission electron microscope (STEM), for the same region as FIG. 9A. Based on a cross-sectional area of the capacitance formation portion Ac, an area percentage of the first secondary phase, relative to an area from which the internal electrode (121 and 122) is excluded, was observed to be 4.58%.

FIG. 9D is an image of a cross-section of a capacitance formation portion of Test Example 1 described below, taken using a transmission electron microscope (TEM), FIG. 9E is an image of elements mapped using energy-dispersive X-ray spectroscopy (EDS) for the same region as FIG. 9D, and FIG. 9F is an image of a region in which first secondary phases are distributed in a dielectric layer selected using a program built into a transmission electron microscope (TEM) for the same region as FIG. 9D. Based on a cross-sectional area of the capacitance formation portion Ac, an area percentage of the first secondary phase included in the dielectric layer, relative to an area from which the internal electrode (121 and 122) is excluded, was observed to be 1.33%.

In an embodiment of the present disclosure, if a secondary phase including calcium (Ca), silicon (Si), and titanium (Ti) and in which an atomic percentage of a rare earth element is 0 at % or more and less than 0.1 at % is referred to as a second secondary phase 142, based on a cross-sectional area of the capacitance formation portion Ac, an area percentage of the second secondary phase 142 included in the dielectric layer 111, relative to an area from which the internal electrode (121 and 122) is excluded, may have a lower limit of 0% or more or 0.05% or more, and an upper limit of less than 0.18. For example, the dielectric layer 111 may not include the second secondary phase 142 (when an area percentage of the second secondary phase is 0%), or may include it in a trace amount of 0.05% or more and less than 0.1% (when an area percentage of the second secondary phase is more than 0.05% and less than 0.1%). In this case, the second secondary phase 142 may be an oxide including oxygen (O), but is not particularly limited thereto, and may be amorphous.

More specifically, if the total number of atoms of all elements in the second secondary phase 142 is 100 at %, calcium (Ca) may be 0.5 at % or more and 10.0 at % or less, silicon (Si) may be 1.0 at % or more and less than 10.0 at %, titanium (Ti) may be 5.0 at % or more and 15.0 at % or less, and rare earth elements may be 0 at % or more and less than 0.1 at %. For example, the second secondary phase 142 may not include rare earth elements (when an atomic percentage of the rare earth element is 0 at %), or may include them but less than 0.1 at %, which may be a noise level (when an atomic percentage of the rare earth element is more than 0 at % and less than 0.1 at %).

Based on a cross-sectional area of the capacitance formation portion Ac, an area percentage of the second secondary phase 141 included in the dielectric layer 111, relative to an area from which the internal electrode (121 and 122) is excluded, may be 0% or more and less than 0.1%, to satisfy target TCC characteristics, for example, X8R characteristics. In this case, the X8R characteristics may mean characteristics satisfying a capacitance change rate (ΔC) of −15% or more and 15% or less at −55° C. to 150° C. based on capacitance (C₈₂₅° C.) at 25° C. (X8R=ΔC/C₈₂₅° C.≤+15% at −55° C. to +150° C.).

When an area percentage of the second secondary phase 141 included in the dielectric layer 111, relative to an area from which the internal electrode (121 and 122) is excluded, is 0.1% or more, based on a cross-sectional area of the capacitance formation portion Ac, there may be a concern that the target TCC characteristics, for example, the X8R characteristics, are not satisfied, and more specifically, the capacitance change rate (ΔC) at 150° C. may exceed +15%, as compared to the capacitance at 25° C. (C₈₂₅° C.).

An area percentage of the second secondary phase 142 included in the dielectric layer 111, relative to an area from which the internal electrode (121 and 122) is excluded, based on a cross-sectional area of the capacitance formation portion Ac may be the same as a method for obtaining an area percentage of the first secondary phase 141 included in the dielectric layer 111, relative to an area from which the internal electrode (121 and 122) is excluded, based on a cross-sectional area of the capacitance formation portion Ac described above, and thus will be omitted. A method of classifying the second secondary phase 142 may be to map calcium (Ca), silicon (Si), and titanium (Ti) through EDS analysis, and classify the region including calcium (Ca), silicon (Si), and titanium (Ti) simultaneously in the dielectric layer 111 as a second secondary phase 142 (for specific criteria on the atomic percentage of each element, refer to an element amount of the second secondary phase 142 described above).

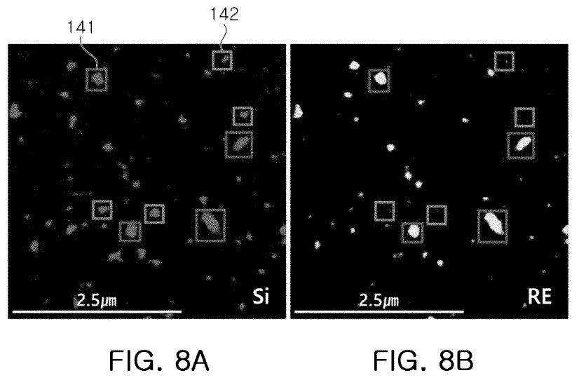

With respect to the method of observing the first and second secondary phases 141 and 142, more specifically, referring to an embodiment of the present disclosure, FIG. 8A is an image of silicon (Si) mapped in a cross-section of a dielectric layer of another embodiment of the present disclosure taken by a scanning transmission electron microscope (STEM) and then by energy dispersive X-ray spectroscopy (EDS), and FIG. 8B is an image of rare earth elements (RE) mapped in the same region by energy dispersive X-ray spectroscopy (EDS). In the above observation region, the first secondary phase 141 may include both silicon (Si) and yttrium (Y), a rare earth element (RE), while the second secondary phase 142 may include silicon (Si). Although separate EDS analysis images for calcium (Ca) and titanium (Ti) are not attached, both the first and second secondary phases 141 and 142 may include calcium (Ca) and titanium (Ti).

Hereinafter, the present disclosure will be described in more detail through test examples, but this may be to help with a specific understanding of the disclosure, and the scope of the present disclosure may not be limited by the test examples.

### Test Examples

The following [Table 1] describes TCC characteristics and high-temperature accelerated life evaluation conducted according to an area percentage of a first secondary phase and whether or not a second secondary phase is included.

For main component base materials of Test Examples 1 to 13, (Ba₁₋ₓCaₓ)TiO₃ (x=0.07) and BaTiO₃ powders, which an average particle size of base material powders is 200 nm, were used together. Using zirconia beads as a mixing/dispersing medium, the main components, (Ba₁₋ₓCaₓ)TiO₃ (x=0.07) and BaTiO₃ powders, and raw material powders including auxiliary components, corresponding to the compositions specified in each of Test Examples to be described below, were mixed with ethanol/toluene solvent and a dispersant, milled for 12 hours, and milled for an additional 12 hours after mixing a binder. A slurry thus manufactured and a molding machine for manufacturing a sheet were used to manufacture a molded sheet with a thickness of 5.1 μm. Next, nickel (Ni) internal electrodes were printed on the molded sheet. Upper and lower cover portions were manufactured by stacking the molded sheets in 15 layers, and a capacitance formation portion was manufactured by stacking the molded sheets in 140 layers. For example, a bar was manufactured by stacking them in a lower cover portion-capacitance formation portion-upper cover portion manner, and the bar was pressed to manufacture a compression bar. The compression bar was cut into chips having a size of 1608 (length×width: 1.6 mm×0.8 mm) using a cutter. 1608-size MLCC chips in which manufacture thereof was completed were calcined, sintered at a temperature of 1250 to 1350° C. for 1.5 to 3 hours in a reducing atmosphere of 1.5% H₂/98.5 to 3.0% H₂/97.0% N₂ (equivalent to H₂O/H₂/N₂ atmosphere, EMF 574 to 731 mV), and then re-oxidized in a N₂ atmosphere of 1050 to 1100° C. for 3 hours to obtain sintered chips. Thereafter, the sintered chips were subject to a termination process and sintering for external electrode with a copper (Cu) paste to complete an external electrode. Therefore, the 1608-size MLCC chips in which a dielectric layer therein had a thickness of approximately 3.5 μm after sintering and 140 dielectric layers were included in the capacitance formation portion were manufactured.

Test Examples 1 to 8 were prepared such that, with regard to the main components of the dielectric layer, (Ba₁₋ₓCaₓ)TiO₃ (x=0.07) and BaTiO₃ powders, a total amount of first auxiliary component elements, Mn and V, is 0.35 moles (Mn 0.15 moles and V 0.20 moles), an amount of a second auxiliary component element, Mg, is 0.5 moles, an amount of a third auxiliary component element, a rare earth element, is 5.5 moles, a total amount of fourth auxiliary component elements, Ba and Ca, is 4.5 moles (Ba 3.5 moles and Ca 1.0 mole), and an amount of the fifth auxiliary component element, Si, is 1.4 moles. Test Examples 1 to 8 applied Y, Sm, Dy, Tb, Ho, Er, Gd, and Yb as the third auxiliary component element, respectively, which was the rare earth element.

Test Examples 9 to 11 added Y as the third auxiliary component element, which was the rare earth element, and the main components and the remaining auxiliary component elements were manufactured in the same manner as Test Examples 1 to 8. To manufacture an area percentage of a first secondary phase or an area percentage of a second secondary phase of Test Examples 9 to 11 differently, sintering times of Test Examples 9 to 11 were the same as that of Test Examples 1 to 8, but sintering atmospheres were applied to Test Examples 9 to 11 differently.

Test Examples 12 and 13 added Y as the third auxiliary component element, which was the rare earth element, and the main components and the remaining auxiliary component elements were manufactured in the same manner as Test Examples 1 to 8. To manufacture an area percentage of a first secondary phase or an area percentage of a second secondary phase of Test Examples 11 to 13 differently, sintering times of Test Examples 12 and 13 were the same as that of Test Examples 1 to 8, but sintering atmospheres were applied to Test Examples 12 and 13 differently.

In the following [Table 1], an area percentage (%) of a first secondary phase may be described by observing an area percentage of a first secondary phase included in the dielectric layer, excluding the internal electrode, based on a 8 μm×8 μm (first direction×second direction) cross-sectional area of the capacitance formation portion. Whether or not a second secondary phase is included may be described by observing an area percentage of a second secondary phase included in the dielectric layer, excluding the internal electrode, based on a 8 μm×8 μm (first direction×second direction) cross-sectional area of the capacitance formation portion. An observation area of the second secondary phase may be the same as an observation area of the first secondary phase. If the area percentage of the second secondary phase is 0% or more and less than 18, it may be evaluated that the second secondary phase is not included, and may be described as “X,” and if the area percentage of the second secondary phase is 1% or more, it may be evaluated that the second secondary phase is included, and may be described as “O.”

A capacitance change rate (ΔC) may be recorded by measuring capacitance change rates at −55° C. (ΔC₈₋₅₅° C.) and 150° C. (ΔC₈₁₅₀° C.) based on capacitance at 25° C. (C₈₂₅° C.). If the capacitance change rate (ΔC) satisfies-15% or more and 15% or less, it may be evaluated as satisfying X8R characteristics, which were target TCC characteristics.

MTTF (hrs) may be mean-time-to-failure (MTTF) by averaging times in which failures were occurred, when performing an accelerated life test (Highly Accelerated Life Time Test, HALT). In the accelerated life test, when a voltage of 75 V was applied at 175° C. for 40 sample chips, if the MTTF was 75 hours or more, it was evaluated as a good product, and if the MTTF was less than 75 hours, it was evaluated as a defective product.

TABLE 1

| | Area | Whether | | | |
|---|---|---|---|---|---|
| | Percentage | or Not | | | MTTF |
| | (%) of 1^{st} | of 2^{nd} | | | (hrs) |
| | Secondary | Secondary | ΔC_{@-55° C.} | ΔC_{@150° C.} | @175° C., |
| | Phase | Phase | (%) | (%) | 75 V |
| Test | 1.33 | X | −4.58 | −14.7 | 82.5 |
| Example 1 | | | | | |
| Test | 2.14 | X | −4.99 | −14.1 | 84.3 |
| Example 2 | | | | | |
| Test | 1.41 | X | −4.05 | −14.2 | 75.6 |
| Example 3 | | | | | |
| Test | 2.94 | X | −4.40 | −13.9 | 79.6 |
| Example 4 | | | | | |
| Test | 1.74 | X | −4.38 | −14.1 | 82.9 |
| Example 5 | | | | | |
| Test | 1.53 | X | −4.66 | −14.5 | 78.9 |
| Example 6 | | | | | |
| Test | 1.26 | X | −4.03 | −14.4 | 75.7 |
| Example 7 | | | | | |
| Test | 2.73 | X | −4.92 | −14.3 | 82.6 |
| Example 8 | | | | | |
| Test | 4.58 | X | −4.42 | −15.4 | 62.2 |
| Example 9 | | | | | |
| Test | 1.28 | X | −4.04 | −14.9 | 75.9 |
| Example 10 | | | | | |
| Test | 2.33 | ◯ | −4.88 | −16.8 | 84.11 |
| Example 11 | | | | | |
| Test | 1.98 | ◯ | −4.06 | −16.1 | 92.5 |
| Example 12 | | | | | |
| Test | 2.64 | ◯ | −4.15 | −18.7 | 103.7 |
| Example 13 | | | | | |

In all of Test Examples 1 to 8, based on a cross-sectional area of the capacitance formation portion, an area percentage of the first secondary phase included in the dielectric layer, excluding the internal electrode, was observed to be less than 4.58%, and based on a cross-sectional area of the capacitance formation portion, an area percentage of the second secondary phase included in the dielectric layer, excluding the internal electrode, was observed to be 0% to less than 1% (including a case in which the second secondary phase was not observed), satisfying X8R characteristics, and accelerated life evaluation was also evaluated as good products in which MTTF was 75 hours or more.

In Test Example 9, based on a cross-sectional area of the capacitance formation portion, an area percentage of the first secondary phase included in the dielectric layer, excluding the internal electrode, was observed to be 4.58%, and based on a cross-sectional area of the capacitance formation portion, an area percentage of the second secondary phase included in the dielectric layer, excluding the internal electrode, was observed to be more than 0% to less than 1%, failing to satisfy X8R characteristics, and accelerated life evaluation was also evaluated as poor products in which MTTF was 62.2 hours. In Test Example 10, based on a cross-sectional area of the capacitance formation portion, an area percentage of the first secondary phase included in the dielectric layer, excluding the internal electrode, was observed to be 1.28%, and based on a cross-sectional area of the capacitance formation portion, an area percentage of the second secondary phase included in the dielectric layer, excluding the internal electrode, was observed to be more than 0% and less than 1%, satisfying X8R characteristics, and accelerated life evaluation was also evaluated as good products in which MTTF was 75.9 hours. In Test Example 11, based on a cross-sectional area of the capacitance formation portion, an area percentage of the first secondary phase included in the dielectric layer, excluding the internal electrode, was observed to be 2.33%, and based on a cross-sectional area of the capacitance formation portion, an area percentage of the second secondary phase included in the dielectric layer, excluding the internal electrode, was observed to be 1% or more, failing to satisfy X8R characteristics, and accelerated life evaluation was also evaluated as good products in which MTTF was 103.7 hours.

In Test Example 12, based on a cross-sectional area of the capacitance formation portion, an area percentage of the first secondary phase included in the dielectric layer, excluding the internal electrode, was observed to be 1.98%, and an area percentage of the second secondary phase included in the dielectric layer, excluding the internal electrode, was observed to be 1% or more, failing to satisfy X8R characteristics, and accelerated life evaluation was also evaluated as good products in which MTTF was 92.5 hours. In Test Example 13, based on a cross-sectional area of the capacitance formation portion, an area percentage of the first secondary phase included in the dielectric layer, excluding the internal electrode, was observed to be 2.64%, and an area percentage of the second secondary phase included in the dielectric layer, excluding the internal electrode, was observed to be 1% or more, failing to satisfy X8R characteristics, and accelerated life evaluation was also evaluated as good products in which MTTF was 103.7 hours.

FIG. 9A is an image of a cross-section of a capacitance formation portion of Test Example 9, taken using a transmission electron microscope (TEM), FIG. 9B is an image of elements mapped using energy-dispersive X-ray spectroscopy (EDS) for the same region as FIG. 9A, and FIG. 9C is an image of a region in which first secondary phases are distributed in a dielectric layer selected using a program built into a transmission electron microscope (TEM) for the same region as FIG. 9A. Based on a cross-sectional area of the capacitance formation portion, an area percentage of the first secondary phase included in the dielectric layer, excluding the internal electrode, was observed to be 4.58%.

FIG. 9D is an image of a cross-section of a capacitance formation portion of Test Example 1, taken through a transmission electron microscope (TEM), FIG. 9E is an image of elements mapped using energy-dispersive X-ray spectroscopy (EDS) for the same region as FIG. 9D, and FIG. 9F is an image of a region in which first secondary phases included in the dielectric layer, relative to an area from which an internal electrode is excluded, are distributed in the dielectric layer selected through a program built into a transmission electron microscope (TEM) for the same region as FIG. 9D. Based on a cross-sectional area of the capacitance formation portion, an area percentage of the first secondary phase included in the dielectric layer, excluding the internal electrode, was observed to be 1.33%.

In addition, the expression ‘an embodiment’ used in this specification does not mean the same embodiment, and may be provided to emphasize and describe different unique characteristics. However, an embodiment presented above may not be excluded from being implemented in combination with features of another embodiment. For example, although the description in a specific embodiment is not described in another example, it may be understood as an explanation related to another example, unless otherwise described or contradicted by the other embodiment.

The terms used in this disclosure are used only to illustrate various examples and are not intended to limit the present inventive concept. Singular expressions include plural expressions unless the context clearly dictates otherwise.

One of various effects of the present disclosure is to improve high-temperature reliability of a multilayer electronic component.

One of various effects of the present disclosure is to implement target TCC characteristics of a multilayer electronic component.

Various advantageous effects of the present 5 disclosure are not limited to the above-described contents, and can be more easily understood in the process of explaining specific embodiments of the present disclosure.

While example embodiments have been illustrated and described above, it will be apparent to those skilled in the art that modifications and variations could be made without departing from the scope of the present disclosure as defined by the appended claims.

What is claimed is:

1. A multilayer electronic component comprising:
a body including a capacitance formation portion including:
a dielectric layer including a main component that includes (Ba, Ca)TiO₃ and BaTiO₃, and
internal electrodes alternately disposed with the dielectric layer; and
an external electrode disposed on the body,
wherein, the dielectric layer includes a first secondary phase including calcium (Ca), titanium (Ti), and 0.1 at % or more of a rare earth element, and
based on a cross-sectional area of the capacitance formation portion, an area percentage of the first secondary phase included in the dielectric layer, excluding the internal electrodes, is more than 0% and less than 4.58%.

2. The multilayer electronic component of claim 1, wherein, a second secondary phase includes calcium (Ca), silicon (Si), titanium (Ti), and 0 at % or more and less than 0.1 at % of the rare earth element, and
based on the cross-sectional area of the capacitance formation portion, an area percentage of the second secondary phase included in the dielectric layer, excluding the internal electrodes, is 0% or more and less than 0.1%.

3. The multilayer electronic component of claim 2, wherein the dielectric layer includes the second secondary phase, and
based on the cross-sectional area of the capacitance formation portion, the area percentage of the second secondary phase included in the dielectric layer, excluding the internal electrodes, is 0.05% or more and less than 0.1%.

4. The multilayer electronic component of claim 2, wherein, based on the cross-sectional area of the capacitance formation portion, the area percentage of the first secondary phase included in the dielectric layer, excluding the internal electrodes, is 1.26% or more and 2.94% or less.

5. The multilayer electronic component of claim 1, wherein the first secondary phase includes at least one of a 1-1 secondary phase having an atomic percentage of silicon (Si) of 1.0 at % or more and 10.0 at % or less, or a 1-2 secondary phase having an atomic percentage of silicon (Si) of 0 at % or more and less than 1.0 at %.

6. The multilayer electronic component of claim 1, wherein the dielectric layer further includes a first auxiliary component element including at least one of manganese (Mn), vanadium (V), chromium (Cr), iron (Fe), cobalt (Co), nickel (Ni), copper (Cu), or zinc (Zn), and a number of moles of the first auxiliary component element included in the dielectric layer, relative to 100 moles of titanium (Ti) included in the dielectric layer, is 0.1 moles or more and 1.0 mole or less.

7. The multilayer electronic component of claim 1, wherein the dielectric layer further includes a second auxiliary component element including magnesium (Mg), and
a number of moles of the second auxiliary component element included in the dielectric layer, relative to 100 moles of titanium (Ti) included in the dielectric layer, is 0.2 moles or more and 0.4 moles or less.

8. The multilayer electronic component of claim 1, wherein the dielectric layer further includes a third auxiliary component element including a rare earth element, and
a number of moles of the third auxiliary component element included in the dielectric layer, relative to 100 moles of titanium (Ti) included in the dielectric layer, is 4.0 moles or more and 7.0 moles or less.

9. The multilayer electronic component of claim 1, wherein the dielectric layer further includes a fourth auxiliary component element including at least one of barium (Ba) or calcium (Ca) by an auxiliary component element additive, and
a number of moles of the fourth auxiliary component element included in the dielectric layer, relative to 100 moles of titanium (Ti) included in the dielectric layer, is 3.0 moles or more and 6.0 moles or less.

10. The multilayer electronic component of claim 1, wherein the dielectric layer further includes a fifth auxiliary component element including silicon (Si), and
a number of moles of the fifth auxiliary component element included in the dielectric layer, relative to 100 moles of titanium (Ti) included in the dielectric layer, is 1.0 mole or more and 2.0 moles or less.

11. The multilayer electronic component of claim 1, wherein the main component consists of (Ba, Ca)TiO₃ and BaTiO₃, and
a molar ratio of (Ba, Ca)TiO₃:BaTiO₃ is from 10:90 to 90:10.

12. A multilayer electronic component comprising:
a body including a capacitance formation portion including a dielectric layer and internal electrodes alternately disposed with the dielectric layer; and
an external electrode disposed on the body,
wherein the dielectric layer includes a first secondary phase, and a second secondary phase,
wherein the first secondary phase includes calcium (Ca), titanium (Ti), and 0.1 at % or more of a rare earth element, and the second secondary phase includes calcium (Ca), silicon (Si), titanium (Ti), and 0 at % or more and less than 0.1 at % of the rare earth element,
wherein, based on a cross-sectional area of the capacitance formation portion, an area percentage of the first secondary phase included in the dielectric layer, excluding the internal electrodes, is more than 0% and less than 4.58%, and
wherein, based on the cross-sectional area of the capacitance formation portion, an area percentage of the second secondary phase included in the dielectric layer, excluding the internal electrodes, is 0.05% or more and less than 0.1%.

13. The multilayer electronic component of claim 12, wherein, based on the cross-sectional area of the capacitance formation portion, the area percentage of the first secondary phase included in the dielectric layer, excluding the internal electrodes, is 1.26% or more and 2.94% or less.

14. The multilayer electronic component of claim 12, wherein the first secondary phase includes at least one of a 1-1 secondary phase having an atomic percentage of silicon (Si) of 1.0 at % or more and 10.0 at % or less, or a 1-2 secondary phase having an atomic percentage of silicon (Si) of 0 at % or more and less than 1.0 at %.

15. The multilayer electronic component of claim 12, wherein the dielectric layer further includes a first auxiliary component element including at least one of manganese (Mn), vanadium (V), chromium (Cr), iron (Fe), cobalt (Co), nickel (Ni), copper (Cu), or zinc (Zn), and
a number of moles of the first auxiliary component element included in the dielectric layer, relative to 100 moles of titanium (Ti) included in the dielectric layer, is 0.1 moles or more and 1.0 mole or less.

16. The multilayer electronic component of claim 12, wherein the dielectric layer further includes a second auxiliary component element including magnesium (Mg), and
a number of moles of the second auxiliary component element included in the dielectric layer, relative to 100 moles of titanium (Ti) included in the dielectric layer, is 0.2 moles or more and 0.4 moles or less.

17. The multilayer electronic component of claim 12, wherein the dielectric layer further includes a third auxiliary component element including a rare earth element, and
a number of moles of the third auxiliary component element included in the dielectric layer, relative to 100 moles of titanium (Ti) included in the dielectric layer, is 4.0 moles or more and 7.0 moles or less.

18. The multilayer electronic component of claim 12, wherein the dielectric layer further includes a fourth auxiliary component element including at least one of barium (Ba) or calcium (Ca) by an auxiliary component element additive, and
a number of moles of the fourth auxiliary component element included in the dielectric layer, relative to 100 moles of titanium (Ti) included in the dielectric layer, is 3.0 moles or more and 6.0 moles or less.

19. The multilayer electronic component of claim 12, wherein the dielectric layer further includes a fifth auxiliary component element including silicon (Si), and a number of moles of the fifth auxiliary component element included in the dielectric layer, relative to 100 moles of titanium (Ti) included in the dielectric layer, is 1.0 mole or more and 2.0 moles or less.

20. The multilayer electronic component of claim 12, wherein the dielectric layer includes a main component that consists of (Ba, Ca)TiO₃ and BaTiO₃, and
a molar ratio of (Ba, Ca)TiO₃:BaTiO₃ is from 10:90 to 90:10.
